(19) United States
(12) Patent Application Publication
(10) Pub. No.: US 2004/0105434 A1
(43) Pub. Date: Jun. 3, 2004

(54) EtherCell

(76) Inventor: Allan Baw, San Jose, CA (US)

Correspondence Address: Allan Baw, 942 Costen Ct., San Jose, CA, 95125, US

(21) Appl. No.: 10/643,117

(22) Filed: Aug. 18, 2003

Related U.S. Application Data
(60) Provisional application No. 60/404,726, filed on Aug. 19, 2002.

(51) Int. Cl. H04L 12/66

(52) U.S. Cl. 370/355; 370/352; 370/493

(57) ABSTRACT

Methods and apparatus for performing call-processing functions of wide-area mobile voice calls over a wireless local-area network (WLAN) are provided. Such methods allow the extension of wide-area call-processing protocols such as Global System for Mobile Communications (GSM) or Code Division Multiple Access (CDMA) into a WLAN which uses a completely different air-interface than GSM or CDMA. Such methods enable wide-area mobile voice communications to be available in a WLAN without the use of any Voice over IP (VOIP) related technologies such as SIP or H.323.

### RELATED APPLICATION

The present application is based on and claims priority from Provisional Patent Application Serial No. 60/404,726 filed on Aug. 19, 2002 and entitled “WLAN Cellular Mobile Services Switch.”

### BACKGROUND OF THE INVENTION

1. Field of the Invention

This invention relates in general to the field of wireless voice communications, in particular to methods and apparatus for enabling wide-area mobile voice communications over a wireless local area network (WLAN).

2. Description of Related Art

The most common form of wireless voice communication is provided by cellular or PCS operators via wide-area mobile voice networks. These wide-area mobile voice networks typically enable mobile voice communication through Global System for Mobile Communications (GSM) or Code Division Multiple Access (CDMA) technologies. Both GSM and CDMA technologies specify the air-interface as well as the call-processing protocols for registering, authenticating, setting up, delivering, and handing off a wireless voice call across the wide-area mobile voice network.

GSM or CDMA based call-processing protocols are only used in the wide-area mobile voice networks and such protocols cannot be extended into a wireless local area network. Typical wireless local area networks such as those based on IEEE 802.11a or 802.11b specifications have been primarily designed to support wireless data communications as opposed to mobile voice communications. Therefore, wireless local area networks are not capable of executing call-processing protocols used in wide-area mobile voice networks such as GSM or CDMA.

Private enterprises and institutions have started implementing wireless voice functions over wireless local area networks by using Voice over IP (VoIP) technology. VoIP technology is typically used in a wired environment, but recent developments have made it possible to extend VoIP onto a wireless local area network.

Therefore, at the present time, the only possible way to introduce voice capability in a wireless local area network is by using VoIP technologies such as Session Initiation Protocol (SIP) or H.323 protocols.

However, when used in a wireless and mobile environment, SIP and H.323 protocols introduce a great amount of call-processing latency and delays in voice signals that are not acceptable for true mobile voice communications. In addition, when using SIP or H.323 in the wireless local area network, no compatibility exists with the call-processing technologies used in the wide-area mobile voice networks such as GSM or CDMA.

Consequently, a cellular or PCS operator cannot extend their wide-area mobile voice communication service offerings based on GSM or CDMA into a wireless local area network that can only support SIP or H.323 protocols.

Accordingly, a need exists for wireless local area networks to acquire the capability to execute GSM or CDMA call-processing protocols.

In doing so, a cellular or PCS operator will be able to extend its wide-area mobile voice communication service offerings into a wireless local area network using its existing GSM or CDMA capabilities and eliminate the compromises of VolP technologies.

In addition, a need also exists for the wide-area mobile voice network to treat the wireless local area network as a typical base transceiver station (BTS) commonly used in wide-area mobile voice networks. Doing so will allow the cellular or PCS operator to provide the most direct and seamless integration between these two types of wireless networks (i.e. wide-area and local) to support mobile voice services. BTS equipment are also known as cell sites and are used to deliver mobile voice services such as cellular or PCS. Accordingly, new technology is required to enable a wireless local area network to emulate the functionality of a BTS in terms of GSM or CDMA protocols.

Current mobile phone devices for the most part support either GSM or CDMA technologies. Such devices are not capable of supporting wireless local area networks air-interfaces based on IEEE 802.11a or 802.11b specifications. Developments are underway to integrate wireless local area network capability into mobile phone devices. As such, the invention described in this application is forward-looking and anticipates the advent of such CDMA or GSM mobile phones that are also capable of supporting the air-interface provided by wireless local area networks.

### BRIEF SUMMARY OF EMBODIMENTS OF THE INVENTION

In accordance with one or more embodiments of the invention, a method is provided for enabling a WLAN to perform the call-processing functions of a base transceiver station (BTS) for enabling mobile voice calls using either CDMA or GSM protocols across the air-interface provided by the WLAN. Such call-processing functions based on either CDMA or GSM protocols include: (a) BTS discovery by the WLAN device; (b) Registration of the WLAN device; (c) Management of 16 kbps voice timeslots via the Transcoder Rate Adaptation Unit (TRAU) interface with the Base Station Controller (BTSC) located at the wide-area mobile voice network; (d) call-origination signaling; (e) call-delivery signaling; (f) IS41 or GSM Authentication procedures; (g) call handoffs.

In accordance with one or more embodiments of the invention, a converged network accessible by wireless client devices is provided. The converged network includes: a wide-area mobile voice network; at least one wireless local area network (WLAN); and a gateway (“EtherCell”) linked to said wide-area mobile voice network and WLANs, said EtherCell providing CDMA or GSM call-processing functions over the WLANs.

In accordance with one or more embodiments of the invention, an EtherCell is provided for performing the CDMA or GSM call-processing functions over a WLAN. The EtherCell includes: a T1 network interface to the Base Station Controller (BTSC); a 10/100BaseT Ethernet interface to the WLAN; a logical A-bis interface via the T1 network interface, a logical Um interface emulation module, an A-bis to WLAN inter-working module.

In accordance with one or more embodiments of the invention, a method is provided for providing the signaling and data link inter-working between a wide-area mobile voice network using CDMA or GSM protocols and a WLAN using ethernet-related protocols. The method includes: (a) taking incoming GSM or CDMA call-processing signaling messages over a T1 interface encapsulated in LAPD frames and converting them into call-processing messages encapsulated in LAPDm over MAC header frames; (b) taking such converted call-processing signaling messages and outputting them over an ethernet interface; (c) perform the aforementioned functions according to A-bis and Um procedures.

In accordance with one or more embodiments of the invention, a method is provided for providing the signaling and data link inter-working between a wide-area mobile voice network using CDMA or GSM protocols and a WLAN using ethernet-related protocols. The method includes: (a) taking incoming call-processing signaling messages over an ethernet interface encapsulated in LAPDm over MAC header frames and converting them into GSM or CDMA call-processing signaling messages encapsulated in LAPD frames; (b) taking such converted call-processing signaling messages and outputting them over a T1 interface; (c) perform the aforementioned functions according to A-bis and Um procedures.

In accordance with one or more embodiments of the invention, a method is provided for emulating GSM BCCH or CDMA Pilot Channels for device and BTS mutual discovery.

In accordance with one or more embodiments of the invention, a method is provided for enabling wireless voice communications via a WLAN and integrate such communication with the wide-area mobile voice network without the use of any VoIP-related technologies such as SIP or H.323.

In accordance with one or more embodiments of the invention, a method is provided for emulating CDMA or GSM call-origination procedures over the air-interface provided by a WLAN. The method includes: (a) execution of Um interface procedures over the air-interface of a WLAN; (b) direct integration of a WLAN with the wide-area mobile voice network via a direct A-bis interface to the BTSC; (c) implementation of IS41 or GSM authentication security procedures over the air-interface of a WLAN; (d) spoofing the BTSC into thinking that the WLAN was a BTS.

In accordance with one or more embodiments of the invention, a method is provided for emulating CDMA or GSM call-delivery procedures over the air-interface provided by a WLAN. The method includes: (a) receiving paging requests from the BTSC and consulting User Profile tables to determine whether the paging request belongs to any of the registered users; (b) use of uniquely assigned MAC addresses as opposed to IP addresses to locate devices; (c) emulation of Um procedures over the air-interface of the WLAN; (d) spoofing the BTSC into thinking that the WLAN was a BTS.

In accordance with one or more embodiments of the invention, a method is provided for enabling the seamless handoff of voice calls between a WLAN and a wide-area mobile voice network. The method includes: (a) procedures for handing off a WLAN voice call into a wide-area mobile voice network; (b) procedures for handing off a wide-area mobile voice call into a WLAN; (c) procedures for handing off a WLAN call into another WLAN.

These and other features will become readily apparent from the following detailed description wherein embodiments of the invention are shown and described by way of illustration the best mode of the invention. As will be realized, the invention is capable of other and different embodiments and its several details may be capable of modifications in various respects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

FIG. 1 shows how the EtherCell integrates a WLAN with a Wide-Area Network and spoofs the wide-area network into thinking that the WLAN is a base transceiver station (BTS).

FIG. 2 illustrates the EtherCell providing the inter-working between a wide-area network and a WLAN

### REFERENCE NUMERALS

10—EtherCell (“The Invention”)

20—Wireless Local Area Network (WLAN) Access Point

22—Wireless Local Area Network (WLAN) Access Point

26—Wireless Local Area Network (WLAN) Access Point

28—Wireless Local Area Network (WLAN) Access Point

30—Wide-Area Network

35—Ethernet Interface to the Wireless Local Area Network (WLAN)

40—Base Transceiver Stations (BTS)

50—Wireless Local Area Network (WLAN)

60—T1 Interface to the Wide-Area Network

### DETAILED DESCRIPTION OF THE PREFERRED EMBODIMENT

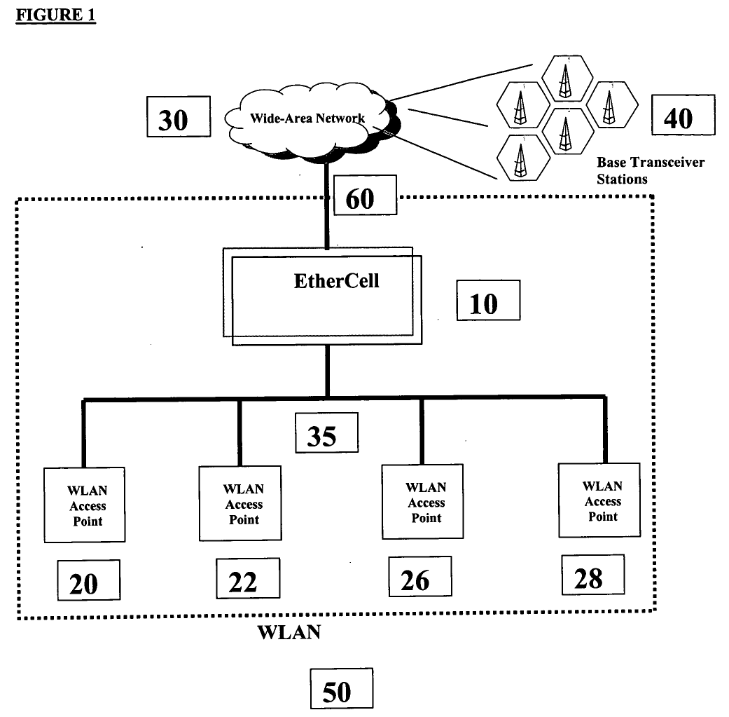

The Invention provides a new type of wide-area network infrastructure for deployment by cellular or PCS operators. Wide-area network infrastructure is deployed by cellular or PCS operators to offer mobile voice communication services. A key component of such wide-area network is the base transceiver station (BTS) equipment (Base Transceiver Stations 40 in FIG. 1). A BTS provides the air interface between the wide-area mobile voice network and the mobile voice service user. The mobile voice service user typically accesses wireless voice services from the wide-are mobile voice network via a mobile device such as a cellular telephone.

The air interface between the wide-area mobile network and the mobile voice service user employs frequency spectrum that is purchased and licensed by the cellular or PCS operator. The air interface is typically based on CDMA, GSM, or TDMA technologies. Current BTS equipment is expensive and has limited capacity for mobile voice services.

The Invention provides a method to provide an alternative to today's expensive BTS equipment by leveraging unlicensed WLAN air interface and frequency spectrum based on IEEE 802.11a or 802.11b specifications. Specifically, The Invention converts a WLAN into behaving like a typical BTS. The combination of The Invention and a WLAN effectively duplicates the functionality of an expensive traditional BTS.

The Invention provides a method to emulate the functionality provided by a wide-area network BTS over a WLAN. The Invention provides the required intelligence to provide radio resource management and general call setup and processing of a wide-area mobile voice call over a WLAN network. In addition, The Invention performs location updates, initial cellular phone registration, and authentication functions by interfacing with a dual-mode cellular phones over the WLAN air interface. The Invention also performs handoff control and communication with the dual-mode cellular phones over the WLAN air interface.

The Invention provides a method to perform inter-working between a WLAN and a wide-area mobile voice network. Such inter-working capability effectively allows cellular or PCS operators to connect and integrate a WLAN to a wide-area mobile voice network. Specifically, The Invention provides a method to carry out signaling communications with a dual-mode cellular phone that is located within an Ethernet frame-based WLAN environment. At the same time, The Invention provides a method for communicating with the wide-area mobile voice network in a timeslot, circuit-switching-based network environment. Such method is described in detail by way of a step-by-step breakdown of the call-flow processes later in this document.

In addition, The Invention provides a method to convert voice signals inside an Ethernet frame-based WLAN environment into timeslots in a circuit-switching-based wide-area mobile voice network environment.

Referring to FIG. 1, the EtherCell (“The Invention”) 10 bridges the gap between a WLAN 50 (consisting of WLAN Access Points 20, 22, 26, and 28) and the Wide-Area Network 30. The Wide-Area Network 30 consists of cellular switching equipment as well as BTS 40. The Invention 10 is connected to the Wide-Area Network 30 via a T1 Interface 60. The Invention 10 is physically located as part of a WLAN 50, and is connected to WLAN Access Points 20, 22, 26, and 28 via an Ethernet Interface 35. Please note that although precisely four WLAN Access Points (20, 22, 26, and 28) are shown in FIG. 1, they are for illustration purposed only and a real-world WLAN network will have varying numbers of WLAN access points. Nevertheless, the WLAN Access Points 20, 22, 26, and 28 are connected together via an Ethernet Interface 35, which also connects to The Invention 10.

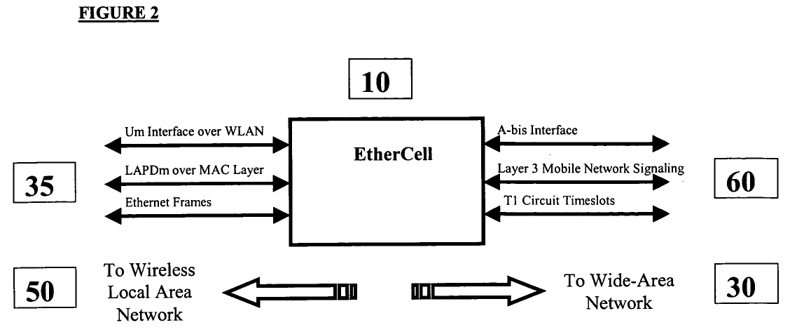

FIG. 2 illustrates the underlying inter-working capabilities of The Invention 10. The Invention 10 is connected to the Wide-Area Network 30 via a T1 Connection 60. The figure depicts the various attributes supported between The Invention 10 and the Wide-Area Network 30 via the T1 Connection 60. At the same time, The Invention 10 is connected to the WLAN 50 via an Ethernet Interface 35. The figure depicts the various attributes supported between The Invention 10 and the WLAN 50 via the Ethernet Interface 35.

Overall, FIG. 2 shows the need for inter-working between the Wide-Area Network 30 and WLAN 50 to deliver mobile voice services via a WLAN 50.

### Detailed Call-Flow Descriptions

Referring to FIG. 1, this section provides a detailed description of the various call scenarios enabled by The Invention 10. The call-flows described in this section are typical scenarios supported by The Invention, and are not intended to be construed as limiting in any manner.

The call-processing scenarios described in this section include:

Registration and Location Update

Call Origination of a voice call from mobile device inside WLAN using wide-area protocols

Call Delivery of a voice call to a mobile device inside a WLAN using wide-area protocols

Call Handoff

Intra-WLAN

WLAN⇄Cellular

Cellular⇄WLAN

Throughout this section, the WLAN air-interface is defined as the wireless link between any of the WLAN Access Points 20, 22, 26, or 28 and the dual-mode cellular phone. A dual-mode cellular phone is defined as a mobile voice device that supports both wide-area protocols such as CDMA or GSM as well as IEEE 802.11a, b, or g protocols. Also, a WLAN refers to the network formed by the combination of WLAN Access Points 20, 22, 26, and 28 via Ethernet Interface 35.

Also, the term “GSM/CDMA” is used to indicate that both signaling protocols are supported by The Invention.

Registration and Location Update

Referring to FIG. 1, a mobile user carrying a dual-mode cellular phone enters the WLAN 50 which is equipped with a WLAN network consisting of various WLAN Access Points (20, 22, 26, and 28). Since The Invention 10 is present inside this WLAN 50, the mobile user will be able to take advantage of the coverage provided by the WLAN network for wide-area mobile voice services.

The first step in accessing mobile voice services via the WLAN is to register and initialize the dual-mode cellular phone. As such, The Invention 10 performs all the behind-the-scenes inter-working with the dual-mode cellular phone and serves as the gateway to the Wide-Area Network 30.

To the Wide-Area Network 30, The Invention 10 appears just like any other BTS equipment such as the ones found at BTS 40. In other words, The Invention 10 makes the Wide-Area Network 30 unaware of the presence of the WLAN (i.e. WLAN Access Points 20, 22, 26, and 28). When communicating with The Invention 10, the Wide-Area Network 30 believes that it is actually communicating with a typical BTS 40.

Conversely, when the dual-mode cellular phone transmits and receives signals from The Invention 10 through the any of the WLAN Access Points 20, 22, 26, or 28, it believes that it is communicating with a typical BTS 40.

In doing so, The Invention 10 effectively converts the WLAN network consisting of WLAN Access Points 20, 22, 26, and 28 into behaving like a typical BTS 40.

The Registration process is broken down into two phases:

a) Registration with the WLAN Network (i.e. WLAN Access Points 20, 22, 26, or 28)

b) Registration with the Wide-Area Network 30

It is important to note that throughout the Registration process, all entities involved in the process, including the dual-mode cellular phone, are uniquely identified by their hard-wired MAC addresses. No IP addresses are required, thus decreasing transaction overhead and improving system performance dramatically.

Registration with the WLAN Network

Referring to FIG. 1, the process is as follows:

1) The mobile user enters the WLAN 50 while carrying a dual-mode cellular phone

2) Once inside, the dual-mode cellular phone performs several tasks:

a. Scans for the presence of Beacon signals broadcast by all of the WLAN Access Points 20, 22, 26, and 28. These Beacon signals are broadcast on a continual basis

b. Scans for the presence of signaling channels (BCCH in the case of GSM or Pilot Channels in the case of CDMA) sent by any nearby BTS 40. For this example, the only presence detected are the Beacon signals sent by the WLAN Access Points 20, 22, 26, and 28 since the dual-mode cellular phone is inside the WLAN 50 and the signals from the BTS are too weak to be picked up by the dual-mode cellular phone

c. Measures the received signal strength (RSS) of all Beacon signals present

d. Locks onto the strongest Beacon signal and captures the MAC address of the associated WLAN Access Point. For illustration purposes, let's assume that the dual-mode cellular phone locks onto the Beacon signal of WLAN Access Point 28.

e. Formulates and sends an IEEE 802.11 Association Request message frame to the access point identified by the capture MAC address. In this case, such access point is WLAN Access Point 28

3) WLAN Access Point 28 receives the Association Request message frame from the dual-mode cellular phone and responds with an IEEE 802.11 Association Response message frame indicating a successful registration with the in-building WLAN

4) In the mean time, The Invention 10 continually broadcasts modified GSM (or CDMA, depending on the chosen air interface of the cellular or PCS operator) signaling messages via the Ethernet Interface 35 to WLAN Access Points 20, 22, 26, and 28. These modified GSM/CDMA signaling message contain information related to:

a. Network Information/Cellular or PCS operator Information

b. Local Area Number

c. The MAC address of The Invention 10 To the Wide-Area Network 30, The Invention 10 appears just like a typical BTS 40, and is uniquely identified by a Base Station ID (in the case of GSM) or PN Offset Value (in the case of CDMA).

On the other hand, the MAC address is required for communications with the dual-mode cellular phone through the WLAN network via the Ethernet Interface 35. The dual-mode cellular phone will uniquely identify The Invention by the MAC address included in this signaling message frame.

5) Once the dual-mode cellular phone is associated with WLAN Access Point 28, it will listen for a GSM/CDMA signaling messages. In this case, the dual-mode cellular phone will capture the signaling message frames sent out by The Invention 10

6) To the dual-mode cellular phone, The Invention 10 appears just like a traditional BTS 40. The only difference is that the GSM/CDMA signaling message frames arrive via an IEEE 802.11 WLAN air link as opposed to timeslot-based cellular air interfaces such as GSM and CDMA.

7) Once the dual-mode cellular phone receives the MAC address of The Invention 10, it is now ready to communicate with The Invention 10 to execute registration with the Wide-Area Network 30.

Registration with the Wide-Area Network 30

During this portion of the overall Registration process, The Invention 10 plays a key role. The Invention 10 will perform the required interworking between the indoor WLAN Access Points 20, 22, 26, or 28 and the Wide-Area Network 30 to execute the registration of the dual-mode cellular phone.

1) Upon receiving the initial GSM/CDMA signaling message frame sent by The Invention 10, the dual-mode cellular phone will responds back by sending a Registration message according to CDMA, TDMA, or GSM formats.

a. The Registration message will contain all pertinent parameters of the dual-mode cellular phone such as Electronic Serial Number (ESN) and Mobile Identification Number (MIN)

b. The dual-mode cellular phone encapsulates the message in IEEE 802.11 MAC headers and sends the message to the MAC address of The Invention 10.

c. The message is transmitted via the WLAN air link.

2) The Invention 10 recognizes its own MAC address, and captures the Registration Message frame sent by the dual-mode cellular phone.

3) The Invention 10 decapsulates the MAC headers and formulates a new outgoing message according to GSM/CDMA Layer 3 signaling message frame formats

a. The Invention 10 will include the Location Area Number in the message to notify the external Wide-Area Network of the current location of the dual-mode cellular phone

b. The Invention 10 then uses LAPD procedures to send the GSM/CDMA Registration message over a D-channel on the T1 Connection 60 between The Invention 10 and the Wide-Area Network 30.

4) The Wide-Area Network 30 receives the Registration message, processes it, and updates its location register with the most current information related to the dual-mode cellular phone

5) The Wide-Area Network 30 updates the profile of the mobile user with its current Location Area Number

6) The Wide-Area Network 30 authentication on the user by comparing the received user information with the stored user information

7) Upon successful authentication, the Wide-Area Network 30 sends a GSM/CDMA signaling message to The Invention 10 to indicate that the dual-mode cellular phone has been authenticated and registered in the Wide-Area Network 30

8) The Invention 10 will bridge the gap between the in-building WLAN network environment and the external cellular environment to ensure that a data link existed between the dual-mode cellular phone and the Wide-Area Network 30 across the WLAN air interface provided by WLAN Access Point 28. Such a data link between the dual-mode cellular phone and the Wide-Area Network 30 is critical in carrying out call-processing functions such as call origination, delivery, and handoffs.

As such, once The Invention 10 is aware that the dual-mode cellular phone has been authenticated, it will assign a Service Access Point Identification (SAPI) value to the dual-mode cellular phone. Such assignment will be used for establishing data links for future communications with the dual-mode cellular phone.

Data link establishment with the dual-mode cellular phone is according to a modified version of LAPD, LAPDm. The Invention 10 will perform the interworking between the LAPD and LAPDm.

9) In addition, upon notification of successful authentication, The Invention 10 will create a User Profile for the dual-mode cellular phone that contains the following parameters:

a. Electronic Serial Number (ESN)

b. Mobile Identification Number (MIN)

c. MAC Address

d. Assigned SAPI Value for LAPDm

e. SAPI Value for LAPD link to external Wide-Area Network

f. MAC Address of the current serving access point

g. Call State

10) The Invention 10 then formulates a layer 3 Successful Registration message frame according to either GSM, TDMA, or CDMA signaling standards

a. This message will also contain the assigned SAPI Value for the LAPDm link for future communications between the dual-mode cellular phone and The Invention 10

b. The message will also inform the dual-mode cellular phone of the SAPI Value associated with The Invention 10 for the LAPDm data link

c. The message is encapsulated into a LAPDm link layer message frame

d. For communication the WLAN Access Point 28, the message is further encapsulated into a MAC layer message frame

i. The Source Address of the MAC layer header is the MAC address of The Invention

ii. The Destination Address of the MAC layer header is the MAC address of the dual-mode cellular phone

iii. All communications between The Invention 10 and WLAN Access Point 28 (or any of the other WLAN Access Points 20, 22, 26) take place over the Ethernet Interface 35

11) The Successful Registration message is sent over the WLAN air link

12) The message arrives at the dual-mode cellular phone and the registration process is now completed

a. The dual-mode cellular phone registers the SAPI Values to be used for future LAPDm link layer communications with The Invention 10

13) For CDMA, The Invention 10 will also keep track and maintain a Neighbor List on behalf of the dual-mode cellular phone

a. This Neighbor List contains a listing of potential handoff candidates including nearby WLAN Access Points and/or BTS

b. The Invention 10 will download the Neighbor List to the dual-mode cellular phone through the WLAN air interface via the pre-established LAPDm data link with the dual-mode cellular phone

Upon completion of the above Registration process, the dual-mode cellular phone can start accessing GSM/CDMA cellular voice services via the any of the WLAN Access Points 20, 22, 26, or 28.

The cellular or PCS operator can configure the frequency of the aforementioned Registration process. Periodic registrations serve as frequent location updates to the Wide-Area Network 30. Such periodic registrations are useful for fault-tolerant purposes and can speed up recovery in case of database failures within the Wide-Area Network 30.

The Invention 10 supports periodic registrations and location updates with the dual-mode cellular phone. The frequency of such updates can vary and represents a trade-off for the cellular or PCS operator between amount of signaling traffic in the network and speed of failure recovery of its databases.

Call Origination from Cellular Phone inside WLAN

Referring to FIG. 1, now that the dual-mode cellular phone is registered and location update completed, the user can start making mobile voice calls via the indoor WLAN network. The Invention 10 performs all the interworking between the dual-mode cellular phone and the Wide-Area Network 30 to make the call possible.

Throughout any of the call setup processes, all communications between the dual-mode cellular phone and The Invention take place via a LAPDm data link using previously assigned SAPI Values during the Registration process.

All signaling messages (either GSM, TDMA, or CDMA) exchanged between the dual-mode cellular phone and The Invention 10 are formatted into LAPDm message frames

The LAPDm message frames are further encapsulated in IEEE 802.11 MAC headers and transmitted across the WLAN air link

Also, all communications between The Invention 10 and the Wide-Area Network 30 are via a traditional T1 Connection 60 using LAPD as the link layer protocol.

The Invention 10 provides the interworking between logical data links that traverse the IEEE 802.11 WLAN air interface (LAPDm over 802.11 MAC) and the data links that traverse the circuit-switched T1 Connection 60 (LAPD)

The Invention 10 also provides the required interworking between message frames that traverse between the IEEE 802.11 air interface (i.e. the wireless link between any of the WLAN Access Points 20, 22, 26, or 28 and the dual-mode cellular phone) and the circuit-switched T1 Connection 60 that connects back to the Wide-Area Network 30

In addition, The Invention 10 provides the required network intelligence to execute GSM / CDMA layer 3 signaling procedures over the IEEE 802.11 WLAN air link. In doing so, The Invention 10 enables GSM / CDMA services over in-building WLAN networks.

On the physical layer, The Invention 10 provides the interworking between Ethernet frames and circuit-switched T1 timeslots (Circuit Emulation).

All signaling messages exchanged between the dual-mode cellular phone and The Invention 10 are layer 3 GSM or CDMA message frames. The Invention 10 provides the network layer call-processing intelligence as well as the necessary data link and physical layer interworking between the 802.11 WLAN network (i.e. WLAN Access Points 20, 22, 26, and 28) and the Wide-Area Network 30

The Invention 10 also allows the cellular or PCS operator to provision and specify the desired balance between voice and data bandwidth requirements over the WLAN. The Invention 10 keeps track of the number of active voice calls over the WLAN, and ensures that the bandwidth usage does not exceed to pre-determined levels. In doing so, the cellular or PCS operator can reserve a desired amount of bandwidth for data services over the WLAN.

Referring to FIG. 1, the call-origination process is thus as follows:

1) The user places the called party number into an originating register in the dual-mode cellular phone, checks to see that the number is correct, and pushes the SEND button.

2) The dual-mode cellular phone sends a Channel Request message to The Invention 10 via the WLAN air link.

3) The Invention 10 detects and captures the message frame arriving via the WLAN air link through the Ethernet Interface 35

4) Upon receiving the Channel Request message frame from the dual-mode cellular phone, The Invention 10 checks the User Profile to:

a. Ensure the dual-mode cellular phone has been registered and initialized

b. Update user location information if necessary

5) The Invention 10 then sends a Channel Required message frame to the Wide-Area Network 30

6) The Wide-Area Network 30 then initiates a connection request

7) At the same time, the Wide-Area Network 30 performs called-party digit analysis and initiates SS7-related call setup procedures with the PSTN

8) The Wide-Area Network 30 then allocates a traffic channel between itself and The Invention 10 and notifies The Invention 10 of such assignment. The signaling between the Wide-Area Network 30 and The Invention 10 is analogous to Q.931 ISDN and follows LAPD procedures

9) Once the bearer path between the Wide-Area Network 30 and The Invention 10 has been established, The Invention 10 will send an Assignment Request message frame to the dual-mode cellular phone, instructing the dual-mode cellular phone to use a previously-assigned logical LAPDm data link for transporting the bearer message frames across the 802.11 WLAN air link

10) The dual-mode cellular phone responds with an Acknowledged message frame

11) The Invention 10 then notifies the Wide-Area Network 30 of the completion of bearer path setup by sending an Assignment Complete message frame

12) Once the called-party answers the phone, conversation starts

13) At this point, the dual-mode cellular phone starts transmitting bearer message frames across the 802.11 WLAN air link

14) The Invention 10 captures these message frames over the previously-assigned logical LAPDm data link for the call, decapsulates all headers related to IEEE 802.11 MAC layer, encodes the message frames into speech, and maps the speech signals over a timeslot on the T1 Connection 60 Such function performed by The Invention 10 is effectively converting voice signals in Voice over Ethernet format into traditional circuit-switched 64 kbps format for transport over the T1 Connection 60. The Invention 10 will include off-the-shelf third party hardware components to perform the speech encoding and decoding functions. The Invention 10 will also utilize third-party off-the-shelf hardware components to support both the Ethernet Interface 35 and the T1 Connection 60.

15) The call is now in progress and The Invention 10 will track the Call State of the conversation and update the associated field in the User Profile accordingly

Call Delivery to Cellular Phone via WLAN

In this scenario, referring to FIG. 1, a call is originated from the PSTN to a dual-mode cellular phone currently being served by The Invention 10 inside WLAN 50 which contains a WLAN network consisting of WLAN Access Points 20, 22, 26, and 28. For this example, it is assumed that the dual-mode cellular phone has already been registered on the Wide-Area Network 30 according to the Registration process discussed earlier in this document.

1) The dialed-digits are forwarded to a Class 5 switch (not shown in FIG. 1) serving the calling party

2) The Class 5 switch performs digit-analysis and recognizes that the number is mobile and forwards the call to the Wide-Area Network 30

3) The Wide-Area Network 30 finds out the current Location Area Number of the dual-mode cellular phone. For this example, let's assume the Location Area Number=8, and that The Invention 10 is one of the “BTS” inside this location area

4) Once the Wide-Area Network 30 determines the Location Area Number of the dual-mode cellular phone, it will instruct all the BTS that belong to Location Area Number 8 to page the dual-mode cellular phone

5) Upon receiving the instruction from the Wide-Area Network 30, The Invention 10 will consult its User Profile registries to determine whether the call request is destined to any of the dual-mode cellular phones currently registered on the WLAN network

6) If the call request is indeed destined for one of the dual-mode cellular phones currently registered with The Invention 10, The Invention 10 will look up its MAC address as well as the SAPI Value assigned to it

7) The Invention 10 will then formulate a Paging Call message, encapsulate it inside a LAPDm frame using the assigned SAPI value, and send it across the 802.11 WLAN air link by further encapsulating the LAPDm message frame with 802.11 MAC layer headers. The message is forwarded to the MAC address of the dual-mode cellular phone

8) Upon receiving the Paging Call message from The Invention 10, the dual-mode cellular phone alerts the user by way of a ringing tone. When the user presses TALK on the dual-mode cellular phone, an Answer message frame is sent back to The Invention

9) The Invention 10 captures the message frame, decapsulates the MAC and LAPDm frame headers, and formulates a new Answer message for communication with the Wide-Area Network 30

a. This message is sent to the Wide-Area Network 30 via a LAPD link on the T1 Connection 60

10) The Wide-Area Network 30 assigns a traffic channel for the call and makes The Invention 10 aware of the assignment

11) The Invention 10 then instructs the dual-mode cellular phone to start forwarding bearer message frames over the 802.11 WLAN air link

12) As discussed previously, The Invention 10 will capture the incoming bearer message frames over the Ethernet Interface 35, decapsulates all headers, encode the voice signal into a speech bit-stream, and map the bit-stream onto an assigned circuit-switched timeslot on the T1 Connection 60 to the Wide-Area Network 30

13) The call is now in progress and The Invention 10 will track the Call State of the conversation and update the associated field in the User Profile accordingly

Call Handoffs

In traditional cellular telephony, handoffs between BTS take place frequently when the mobile user is in motion and on the move. During a voice call, two parties are on a voice channel. When a dual-mode cellular phone moves out of the coverage area of a particular cell site, the reception becomes weak. At this point, the present BTS may request a handoff. The system switches the call to a new frequency channel in a new cell site without either interrupting the call or alerting the user. The call continues as long as the user is talking. The users do not notice the handoff occurrences. This handoff scenario is classified as network-controlled handoff (NCHO) and is used in older analog mobile systems.

For the current generation of mobile systems such as GSM, TDMA, and CDMA, mobile-assisted handoff (MAHO) is used instead of NCHO. In this case, the Wide-Area Network asks the dual-mode cellular phone to measure the signal from the surrounding base stations. The Wide-Area Network makes the handoff decision based on reports from the dual-mode cellular phone.

Referring to FIG. 1, when a mobile user is inside WLAN 50 and is accessing mobile voice services via the WLAN network, The Invention 10 performs all the behind-the-scenes interworking with the Wide-Area Network 30 to execute the voice call handoff. The entire process will be transparent and seamless to the mobile user. At the same time, to the Wide-Area Network 30, the handoff process appears to be a typical inter-BTS handoff. Thanks to The Invention 10, the indoor WLAN network appears just like a typical BTS 40 to the Wide-Area Network 30.

The Invention 10 is effectively a “black box” that hides the WLAN-specific features from the Wide-Area Network 30, and vice versa. Thus, the indoor WLAN looks like a traditional cellular base station represented by BTS 40 to the Wide-Area Network 30.

Again, the term WLAN Network is used to represent the combination of WLAN Access Points 20, 22, 26, and 28 via Ethernet Interface 35. The call handoff scenarios supported by The Invention 10 include:

Inter-WLAN Access Point Handoff

WLAN Network to Wide-Area Network 30 Handoff

Wide-Area Network 30 to WLAN Network Handoff

Inter-WLAN Access Point Handoff

Referring to FIG. 1, the process for enabling the handoff of a GSM / CDMA over WLAN voice call between two WLAN Access Points is as follows:

1) Periodically, The Invention 10 will send out signaling message frames to the dual-mode cellular phone to request the dual-mode cellular phone to measure the received signal strength (RSS) from surrounding WLAN Access Points (20, 22, 26, or 28) as well as from external cell site base stations represented by BTS

2) The dual-mode cellular phone will report back to The Invention 10 the RSS from its current point of attachment as well as neighboring points of attachment. If the dual-mode cellular phone is in the process of walking outside the WLAN 50 towards the Wide-Area Network 30, it will include the RSS from the nearest external cellular base station found in one of the BTS 40.

3) In this example, however, the dual-mode cellular phone is not leaving the WLAN and the in-building WLAN network, and is merely transitioning between the coverage areas of two different WLAN Access Points. Thus it will only report back the RSS from the surrounding access points. For this example, let's assume that these two access points are WALN Access Point 26 and WLAN Access Point 28. WLAN Access Point 26 represents the new WLAN Access Point while WLAN Access Point 28 represents the current point of attachment

4) Once The Invention 10 receives the RSS measurements from various neighboring WLAN access points from the dual-mode cellular phone, it will make a handoff decision based on those parameters. Specifically, The Invention 10 will execute a proprietary algorithm that compares these various parameters and decide on when to make the handoff.

5) If The Invention 10 determines that a handoff to the Wide-Area Network 30 is not required, then no action is taken since inter-WLAN access point handoff is dual-mode cellular phone-initiated, as previously indicated

6) In this example, the dual-mode cellular phone compares the measured RSS of the Beacon signals from various neighboring access points. It determines that a handoff is needed and locks onto the strongest Beacon signal. This Beacon signal belongs to the new WLAN access point (WLAN Access Point 26)

7) The dual-mode cellular phone then sends an IEEE 802.11 Re-Association Request message to the WLAN Access Point 26. This message contains the MAC addresses of the dual-mode cellular phone as well as that of the old access point (WLAN Access Point 28)

8) WLAN Access Point 26 responds with a Re-Association Response message

9) The dual-mode cellular phone is now in communication with WLAN Access Point 26 and will respond exclusively to WLAN Access Point 26 from this point on

10) WLAN Access Point 26 then sends a Handover Request according to the Inter Access Point Protocol (IAPP) to WLAN Access Point 28. WLAN Access Point 28 then responds with a Handover Response message

11) While the dual-mode cellular phone is transitioning between the two WLAN access points, The Invention 10 continues to transmit message frames to the dual-mode cellular phone's MAC address. This logical transmission link is not affected by the dual-mode cellular phone's movement between two access points. This holds true for the reverse path as well. Therefore, the call session is never interrupted during the handoff

12) The Invention 10 becomes aware of the dual-mode cellular phone's new point of attachment (i.e. MAC address of WLAN Access Point 26) through periodic Registration and Location Update signaling message exchanges with the dual-mode cellular phone. Such process was described earlier in this document

13) Once The Invention 10 receives the location update from the dual-mode cellular phone, it will update the User Profile to reflect the current location of the dual-mode cellular phone. The handoff process is now complete.

The ability to know exactly which access point is serving the dual-mode cellular phone has significant and compelling ramifications for the cellular or PCS operator. For example, the cellular or PCS operator will now be able to pinpoint the specific location of the dual-mode cellular phone to within 150′ of the location of the serving access point. Such ability is especially critical in ensuring compliance with the E911 FCC mandate. In addition, the cellular or PCS operator will be able to offer location-based services and targeted advertising to the mobile users

WLAN Network to Wide-Area Network Handoff

In this scenario, referring to FIG. 1, the mobile user is involved in a phone conversation while inside the coverage area of the indoor WLAN Network (i.e. the mobile user is currently inside WLAN 50). The mobile user then migrates outside WLAN 50 towards the coverage area of the Wide-Area Network 30 while remaining engaged in the phone conversation.

The handoff of this voice call from the indoor WLAN Network to the Wide-Area Network 30 is as follows:

1) The dual-mode cellular phone measures the received signal strength (RSS) from surrounding WLAN Access Points as well as from external cell site base stations (i.e. BTS 40)

2) The dual-mode cellular phone reports back to The Invention 10 the RSS measurements from the various potential points of attachment. In this case, since the dual-mode cellular phone is in the process of walking outside the indoor network towards the external mobile Wide-Area Network 30, it will include the RSS from nearby external cell site base stations that are part of BTS 40. The dual-mode cellular phone reports back the RSS measurements twice every second

3) Once The Invention 10 receives the RSS measurements from the dual-mode cellular phone, it will make a handoff decision based on those parameters. Specifically, The Invention 10 will execute a proprietary algorithm that compares these various parameters and decide on when to make the handoff.

4) In order to avoid repeated handoffs back and forth between two points of attachment, additional handoff parameters are considered by the algorithm to make more intelligent handoff decisions. Another factor to be considered in making the handoff decision is whether the handoff candidate (i.e. the potential new point of attachment) has enough bandwidth or capacity to support the call. The Invention 10 will perform this verification to ensure that the probability of call-blocking or call-dropping during handoff is minimized.

5) In this case, The Invention 10 determines that a handoff is necessary towards an external cell site base station that is part of BTS 40.

6) The Invention 10 formulates a Handover Request message frame and sends it to the Wide-Area Network 30

7) The Wide-Area Network 30 looks up a list of potential handoff candidates and sends a Handover Request message to the handoff candidate base station (“new base station”) that is part of BTS 40

8) The new base station activates a new traffic channel in anticipation of the handoff, and sends an Acknowledge message back to the Wide-Area Network 30

9) The Wide-Area Network 30 then sends a Handover Command message to The Invention 10 with the following parameters:

a. New traffic channel information

b. Power Level to be used

c. Type of handoff

d. New signaling channel assignment for communication with the new base station

10) The Invention 10 then translates and maps this GSM/CDMA/TDMA Handover Command signaling message into 802.11 by first forming a LAPDm message frame, and then further encapsulates it with 802.11 MAC layer headers. This message is then sent across the 802.11 WLAN air link towards the dual-mode cellular phone

11) The dual-mode cellular phone moves into the coverage area of the new base station, connects to it and tunes to the assigned signaling channel. The dual-mode cellular phone now converts back into cellular mode

12) The dual-mode cellular phone now communicates directly with the new base station via the newly assigned signaling channel and sends a Handoff Access message to the new base station

13) The new base station then sends a Handover Complete message to the Wide-Area Network 30

14) The Wide-Area Network 30 then notifies The Invention 10 to release any communication links with the dual-mode cellular phone.

15) The Invention 10 then updates the User Profile and clears the information related to the dual-mode cellular phone which has now moved beyond the coverage area of the indoor WLAN network. The handoff is now complete

Wide-Area Network to WLAN Handoff

Referring to FIG. 1, this scenario is the reverse of handoff scenario described in the previous section. Once again, to the Wide-Area Network 30, The Invention 10 appears just like any other traditional cell site base station. Therefore, The Invention 10 is provisioned at the Wide-Area Network 30 and recognized as one of the potential handoff candidates.

The handoff process is as follows:

1) The dual-mode cellular phone measures the RSS of neighboring points of attachment. In this case since the mobile user is moving indoors towards WLAN 50 and into the coverage area of the WLAN network, it will obtain Beacon signal measurements from any of the WLAN Access Points (20, 22, 26, or 28).

2) The dual-mode cellular phone reports back the RSS measurements to the current serving base station that is one of the cell sites found inside BTS 40 (“old base station”) twice every second

3) In this case, the old base station determines that a handoff is required. It then sends a Handover Required message to the Wide-Area Network 30

4) The Wide-Area Network 30 then looks up it list of handoff candidates (The Invention 10 is provisioned as one of the handoff candidates), and determines that a handoff towards The Invention 10 is required

5) The Wide-Area Network 30 will then send a layer 3 GSM/CDMA Handover Request message to The Invention 10.

6) Upon receiving the message, The Invention 10 checks to determine whether there is enough bandwidth to support a new voice session within the WLAN network (i.e. if the pre-determined maximum number of simultaneous voice calls has been reached).

7) In this case, The Invention 10 determines that the handover request can be supported. It will then send back an Acknowledge message to the Wide-Area Network 30 which contains the following parameters:

a. New Channel Info=MAC address of The Invention

b. Power Level=Per 802.11 specifications

c. Type of Handoff=Hard Handoff

d. New Signaling Channel Assignment=Beacon Signal of New Access Point

By including the above parameters in the Acknowledge message, The Invention 10 is mapping IEEE 802.11 WLAN-specific values to traditional cellular- handoff parameters. In doing so, The Invention 10 effectively bridges the gap between these two heterogeneous network environments and enables seamless handoffs between the two disparate networks.

8) The Wide-Area Network 30 then forwards the handoff parameters to the old base station with a Handover Command message. The old base station in turn relays the message to the dual-mode cellular phone

9) The dual-mode cellular phone then releases the old traffic channel, and starts scanning for the Beacon signal of the access point it is handing off to (“new WLAN access point”)

10) The dual-mode cellular phone locks onto the Beacon signal of the new WLAN access point, and sends an 802.11 Association Request message to the new access point. For this example, let's assume that this new access point is WLAN Access Point 22.

11) WLAN Access Point 22 responds with an 802.11 Association Response message

12) Once the dual-mode cellular phone locks onto WLAN Access Point 22, it sends a Handoff Access message encapsulated in 802.11 MAC headers to The Invention 10. The dual-mode cellular phone obtained the MAC address of The Invention 10 in the Handover Command message

13) The Invention 10 receives the Handoff Access message, registers the parameters related to the dual-mode cellular phone in the User Profile, assigns a SAPI for communication with the dual-mode cellular phone over a LAPDm data link, and captures the MAC address of the dual-mode cellular phone from the MAC layer header sent by the dual-mode cellular phone

14) The Invention 10 then sends a Handover Complete message frame to the Wide-Area Network 30

15) The Wide-Area Network 30 notifies the old base station to release links and traffic channel previously used by the dual-mode cellular phone. The Wide-Area Network 30 then starts forwarding the voice call to The Invention 10 via a chosen timeslot on the T1 Connection 60 to The Invention 10

16) The Invention 10 receives the voice signal over the circuit-switched T1 Connection 60 timeslot, decodes the speech signal into a bit-stream, and maps this bit-stream into LAPDm message frames encapsulated in 802.11 MAC layer headers. The Invention 10 then forwards these formatted voice message frames to the dual-mode cellular phone over the 802.11 WLAN air link

17) The mobile user continues the conversation without interruptions. The handoff is now complete

1) A method for enabling wide-area mobile voice communications over a wireless local area network without the use of Voice over Internet Protocol (VoIP) technologies.

2) A method for executing wide-area mobile voice call-processing protocols over a wireless local area network.
